(19) United States
(12) Patent Application Publication
(10) Pub. No.: US 2025/0115414 A1
(43) Pub. Date: Apr. 10, 2025

(54) TRANSVERSE FORCE ACTIVATED PRESSURE VESSEL

(71) Applicant: AKTIVAX, INC., Broomfield, CO (US)

(72) Inventor: Amir Genosar, Broomfield, CO (US)

(21) Appl. No.: 18/682,574

(22) PCT Filed: Aug. 11, 2022
(86) PCT No.: PCT/US2022/074848

§ 371 Date: Feb. 9, 2024

Related U.S. Application Data
(60) Provisional application No. 63/232,553, filed on Aug. 12, 2021.

(51) Int. Cl. B65D 83/38; B01D 63/08; B65D 83/206

(52) U.S. Cl. CPC B65D 83/382; B01D 63/087; B65D 83/206

(57) ABSTRACT

A pressure vessel with an interior adapted to contain a pressurized substance is provided. The pressure vessel includes a membrane including an interior surface exposed to the interior of the pressure vessel, the membrane adapted to hermetically seal the pressure vessel in an intact state and to release the pressurized substance in a ruptured state. The pressure vessel further includes an actuating rod coupled to and extending from an exterior surface of the membrane on an opposite side of the membrane relative to the interior surface, the actuating rod adapted to transition the membrane from the intact state to the ruptured state in response to receiving a transverse force.

### CROSS-REFERENCE TO RELATED APPLICATIONS

The present application claims benefit of priority to U.S. Provisional Patent Application No. 62/232,553, entitled “Sealed Pressurized Gas Vessel with Low Force Opening Mechanism” and filed on Aug. 12, 2021. This application is incorporated by reference for all that it discloses or teaches. In the event of any conflict between the definition or use of any term between the present application and any application incorporated by reference, the definition or use in this application controls.

### BACKGROUND

Single-use pressure vessels include membranes (e.g., rupturable membranes) that are typically manufactured to be thick and rigid so as to withstand very high pressures. As a result, an actuator of a single-use pressure vessel must exert a considerable amount of pressure to rupture the pressure vessel's membrane. Some versions of these single-use pressure vessels may rely on spring-powered motion to rapidly rupture the membrane, though these mechanisms may be complicated, may be expensive to manufacture, and may present reliability concerns.

### SUMMARY

The described technology provides a pressure vessel with an interior adapted to contain a pressurized substance is provided. The pressure vessel includes a membrane including an interior surface exposed to the interior of the pressure vessel, the membrane adapted to hermetically seal the pressure vessel in an intact state and to release the pressurized substance in a ruptured state. The pressure vessel further includes an actuating rod coupled to and extending from an exterior surface of the membrane on an opposite side of the membrane relative to the interior surface, the actuating rod adapted to transition the membrane from the intact state to the ruptured state in response to receiving a transverse force.

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1A illustrates an example pressure vessel, including a membrane in an intact state.

FIG. 1B illustrates an example pressure vessel, including a membrane in a ruptured state.

FIG. 1C illustrates another example pressure vessel, including a membrane in a ruptured state.

FIG. 2 illustrates a detailed section view of an example pressure vessel, which includes an activation lever.

FIG. 3 illustrates a detailed section view of an example pressure vessel, which includes an interior piercing member.

FIG. 4 illustrates a detailed section view of an example of a side of a pressure vessel.

FIG. 5 illustrates an example of a pressure vessel, which includes a biasing element and an actuator.

FIG. 6 illustrates a detailed section view of an example of a pressure vessel, including an actuating rod with a sharp portion.

FIG. 7 illustrates example operations of rupturing a membrane that hermetically seals a pressure vessel in an intact state.

### DETAILED DESCRIPTION

Pressure vessels are broadly used in industrial, home, and recreational applications. Pressure vessels include a body opened on one end and a valve joined to this opening in a fluid-tight fashion. The fluid-tight or hermetic coupling contains the pressurized gas within the body and allows the gas to be released from the pressure vessel when actuated. Several classes of pressure vessels are intended for repeated use, and hence the valve is configured to be opened and closed. Several classes of pressure vessels are intended to be refilled, and hence the valve is configured to allow the flow of pressurized contents into the pressure vessel. Single-use pressure vessels typically comprise a membrane in place of a reclosable valve. Typically, a separate device comprising a threaded well and a rigid spike is used to puncture the membrane.

Single-use pressure vessels are used in a variety of applications, such as bike tire inflators, automotive air conditioning system rechargers, paintball guns, sparkling water makers, and medical devices. The membrane (e.g., a rupturable membrane adapted to be ruptured or a decouplable membrane decouplable from a cap or body of the pressure vessel) is typically manufactured to be thick and rigid so as to withstand very high pressures. The actuator must therefore exert a considerable amount of force to rupture the membrane. Some versions of these vessels may rely on actuating mechanisms (e.g., spring-powered mechanisms) to rapidly rupture the membrane by applying a force directed at the membrane, though these mechanisms may be complicated, may be expensive to manufacture, may require overcoming high resistance from the pressurized contents to rupture a membrane, and/or may present reliability concerns.

Rupturing a membrane by applying a transverse force that causes an actuating rod (e.g., an elongate member) to torque a portion of the membrane can reduce the amount of force needed to rupture a membrane when compared with a direct application of force towards the membrane. As used herein, rupturing of the membrane can include one or more of piercing at least a portion of the membrane, otherwise breaking at least a portion of the membrane, or decoupling at least a portion of the membrane from a cap and/or the pressure vessel. For example, implementations of the presently described technology provide a pressure vessel that includes an actuating rod coupled to a membrane. The membrane defines a portion of the pressure vessel (or otherwise hermetically seals the pressure vessel) such that pressurized contents of the pressure vessel may apply pressure to an interior surface of the membrane. When the actuating rod receives a transverse force applied to a lateral side of a distal portion of the actuating rod, the actuating rod may rotate to torque the membrane at a coupling between the membrane and the actuating rod and cause a portion of the membrane to rupture.

If the membrane is adapted to rupture outwardly relative to the pressure vessel, the force applied by pressurized contents in the interior of the pressure vessel contributes to the rupture rather than opposes the rupture. For example, implementations of the presently described technology include a membrane that is configured to rupture outwardly by the actuating rod torquing and/or rotating a portion of the membrane relative to the rest of the membrane and/or relative to rigid elements of the pressure vessel and/or the cap to which the membrane is coupled.

Positioning elements of the actuating rod on the interior of the pressure vessel such that the actuating rod extends through the membrane to both sides of the membrane can increase the translation of the transverse force and torque applied to the membrane. For example, implementations of the presently disclosed technology provide an actuating rod that has portions extending from each of an interior surface and an exterior surface of a membrane. This may increase the surface area over which the actuating rod engages and/or is coupled to the membrane, reducing the pressure applied at any particular point in the engagement of the coupling between the actuating rod and the membrane to rupture the membrane.

In an implementation, a portion of the actuating rod positioned in the interior of the pressure container prior to rupture of the membrane may include a piercing member. The piercing member may rupture the membrane by piercing the membrane. Because the piercing member is positioned in the interior of the pressure vessel, the amount of pressure the piercing member applies to pierce the membrane is less than if the piercing element were positioned externally of the pressure vessel. Implementations are also contemplated in which the rupture of the membrane includes severing a coupling between the membrane and a rigid portion of the pressure vessel or the cap such that the membrane is peeled away from the pressure vessel or the cap.

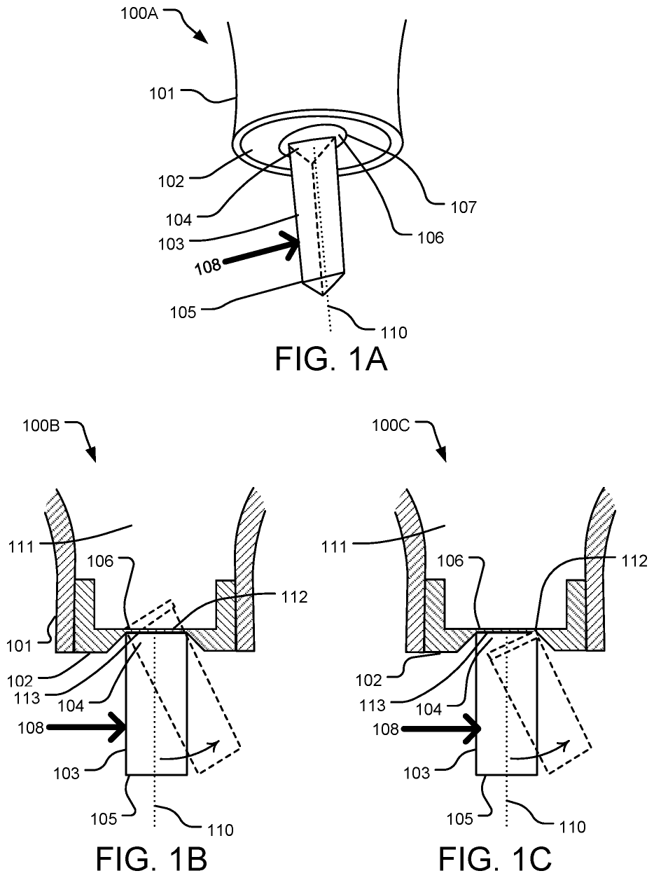

FIGS. 1A-1C illustrate example pressure vessels 100A-100C. Specifically, FIG. 1A illustrates an example pressure vessel 100A (or ‘vessel’), including a membrane 106 in an intact state. The pressure vessel includes a body 101 and a cap 102. In an implementation, the membrane 106 may be rupturable or may be decouplable from one or more of the body 101 and the cap 102. The body 101 may comprise metals or alloys such as steel, stainless steel, or aluminum. The cap 102 may be coupled to the body in a fluid-tight fashion to hermetically seal pressurized contents within the body 101. In an implementation, the cap 102 is sealed between rigid portions or otherwise coupled to a rigid portion of the body 101. The pressurized contents may include a pressurized fluid that is compressed and/or liquified. Examples of pressurized contents containable within the pressure vessel 100 include carbon dioxide, oxygen, nitrogen, argon, helium, hydrocarbons, fluorocarbons, ethers, or a mixture of gasses or other pressurized fluids. Examples of common liquified gasses include fluorocarbons, ethers, and other hydrocarbons.

In an implementation, the cap 102 includes a membrane 106. The cap 102 and/or the membrane 106 may be coupled to or integral with an actuating rod 103. The actuating rod 103 includes a proximal portion 104 (e.g., a proximal end) joined to the membrane 106 and a distal portion 105 (e.g., a distal end) extending distally away from the membrane 106. In an implementation, when a transverse force 108 is applied to the distal portion 105, the proximal portion 104 torques against a coupled portion of the membrane 106, causing the actuating rod to rupture the membrane 106 (e.g., pierce the membrane 106 or decouple the membrane 106 from one or more of the cap 102 and the body 101). The arrangement is such that when the distal portion 105 is moved in a direction generally perpendicular to the virtual line or central longitudinal axis 110 between the distal portion 105 and the proximal portion 104, the proximal portion 104 manipulates the membrane 106 to rupture. In an implementation, the received (or actuated) transverse force 108 is an eccentric force that transitions the membrane 106 from the intact state to the ruptured state by rotating the actuating rod 103 substantially around the coupling between the actuating rod 103 and the membrane 106. In an implementation, two or more of the cap 102, actuating rod 103, and the membrane 106 are manufactured together as a singly formed component.

In an implementation, the membrane 106 ruptures to transition from the intact state to the ruptured state responsively to the received transverse force satisfying a rupture condition. In an implementation, the rupture condition may be based on a predetermined force threshold based on one or more of a pressure applied by the pressurized substance to the membrane, a configuration (e.g., the composition or thickness) of the membrane 106 (and/or the weakened portion 107), a configuration of the actuating rod 103 relative to the membrane 106, a configuration of an actuator configured to apply the transverse force 108 to the actuating rod 103, a biasing force (e.g., a spring force) that a biasing element (e.g., a spring, an elastic band, or a pneumatic element) is configured to selectively (e.g., responsive to a releasing action) apply to the actuator, and the like.

In an implementation, the received (or actuated) transverse force 108 is a force that has a component that is substantially perpendicular to a central longitudinal axis 110 along a longitudinal length of the actuating rod 103. In an implementation, the component of the transverse force 108 that is substantially perpendicular to the central longitudinal axis 110 along the longitudinal length of the actuating rod 103 is greater than a component of the force that is parallel to the central longitudinal axis. In implementations in which the actuating rod 103 is differently shaped, the central longitudinal axis 110 that represents a reference for the transverse force 108 may be virtually represented as a line substantially normal to the membrane 106 at a point (e.g., a central point) of the coupling between the membrane 106 and the actuating rod 103.

In an implementation, one or more of the cap 102 and the membrane 106 includes the thinned or weakened portion 107. In implementations, the weakened portion 107 in the cap 102 may at least partially define the membrane 106. The weakened portion 107 may be adapted to selectively rupture when sufficient force is applied. In an implementation, the weakened portion 107 couples the membrane 106 to the cap 102 and/or the body 101. In another implementation, the weakened portion 107 couples the cap 102 to the body 101, with the cap 102 serving as the membrane 106. The weakened portion 107 may be a portion of the membrane 106 and/or the cap 102 that is thinned (or molded to have a thinner width through which to rupture than other portions of the membrane 106 or the cap 102) or of a different composition than other, more rigid portions of the membrane 106 and/or the cap 102. In an implementation, the weakened portion at least partially circumscribes the coupling between the actuating rod 103 and the membrane. In an implementation, the weakened portion is weakened asymmetrically around the coupling between the actuating rod 103 and the membrane 106.

In the illustrated implementation, the actuating rod 103 is illustrated as an elongate member. Implementations are contemplated in which the actuating rod 103 is of a different shape, including one or more of a different three-dimensional polygon, a three-dimensional object with curvilinear sides, any combination thereof, and any other three-dimensional shape.

FIGS. 1B and 1C illustrate example pressure vessels 100B and 100C with a membrane 106 in a ruptured state. In implementations, the pressure vessels 100B and 100C are implementations of the pressure vessel 100A after the pressure vessel 100A has been ruptured. Specifically, FIG. 1B illustrates an example pressure vessel 100B, including a membrane 106 in a ruptured state. The membrane 106 of the pressure vessel 100B is ruptured inwardly into an interior 111 of the pressure vessel 100B. In an implementation, the proximal portion 104 ruptures the membrane 106 inwardly. In this implementation, the membrane 106 may remain partially joined to the membrane on the side of the coupling between the membrane 106 and the actuating rod 103 from which an actuating force is applied to the distal portion 105 of the actuating rod 103.

FIG. 1C illustrates another example pressure vessel 100C, including a membrane 106 in a ruptured state. The membrane 106 of the pressure vessel 100C is ruptured outwardly to extend distally from the pressure vessel 100C (or distally from the location of the rupture). In an implementation, the transverse force 108 causes a transverse actuation of the actuating rod 103 that ruptures the membrane 106 outwardly from the pressure vessel 100A in substantially the same direction as a pressure force applied to the membrane 106 by the contained pressurized substance. In an implementation, the actuating rod 103 is adapted to deform the membrane 106 during the transition to increase a hermetically sealed volume contained by the membrane 106 and the pressure vessel 100C prior to rupturing the membrane. Moving the membrane 106 outwardly may cause the volume contained by the membrane 106 and the body 101 to increase (e.g., increasing the volume of the pressurized contents contained within the pressure vessel 100C) before the membrane 106 is ruptured. In an implementation in which an interior portion of the actuating rod is situated in the interior 111 of the pressure vessel 100A in the intact state, a greater portion of the actuating rod 103 is in the interior 111 of the pressure vessel 100A in the intact state than in the pressure vessel 100C in the ruptured state.

In FIG. 1C, the proximal portion 104 ruptures the membrane 106 outward and may remain partially joined to the membrane on the side opposite that from which an actuating force is applied to the distal portion 105 of the actuating rod 103. The manner in which the actuating rod 103 is configured to rupture, fracture, or decouple the membrane 106 may be controlled by the physical geometry of the actuating rod 103 or membrane 106. For example, the geometry could include a frangible indentation, slit, notch, or series of notches in either or both of the actuating rod 103 and the membrane 106 of the pressure vessel 100. The pressure vessel 100 may be manufactured without a cap 102, wherein the membrane 106 is joined to the body 101 in a fluid-tight fashion.

The actuating rod 103 may comprise a piercing member having a geometry that follows the geometry of the membrane 106 and/or force concentration features in a confronting position to the membrane 106 to facilitate rupturing of the membrane 106. In this and other embodiments, the force concentration features and/or geometry that follow the geometry of the membrane 106 or a weakened portion (e.g., a rupturable region) of the membrane 106 can be incorporated directly into the actuating rod 103. In an implementation, following the geometry of the membrane 106 means that the membrane 106 and/or the weakened portion is substantially the same size and/or shape as the surface area of elements of the actuating rod 103 that interface with or contact the membrane 106 and/or the weakened portion. In an implementation, following the geometry means that a projection of the actuation rod 103 elements such as a piercing member or force concentration feature onto the membrane 106 at least partially defines the weakened portion of the membrane 106. For example, in an implementation, the weakened portion is broadly the same shape as the footprint of the force concentration feature on the membrane 106. For example, if the force concentration feature is radially symmetric, the weakened portion would be radially symmetric; if the force concentration feature is an ax-head shape, the weakened portion is similarly oblong.

As shown in FIGS. 1B and 1C in dashed lines, the actuating rod 103 ruptures the membrane 106 when a transverse force 108 is applied to the actuating rod 103. Applying the transverse force 108 to the distal portion 105 provides a mechanical force advantage compared with applying a direct force to the actuating rod 103 in the direction of the membrane 106. The transverse force 108 required to rupture the membrane 106 may be less than the direct force in the direction of the membrane required to rupture the membrane. In an implementation, the actuating rod may have a triangular or another edged or sharp profile, which further decreases the actuating force required to rupture the membrane 106 at a point of interaction of a vertex, edge, or corner of the edged or sharp profile and the membrane 106.

In implementations, the actuating rod 103 may be further coupled at the distal portion 105 to an actuator (e.g., a lever) that applies the transverse force 108 to the actuating rod 103. In an implementation, the actuator is coupled to the body 101 by a biasing element (e.g., a spring, elastic band, or a pneumatic/pressurized element) coupled to the pressure vessel 100. For example, the biasing element may be adapted to apply a triggering force to the actuation lever responsive to a release of the biasing element, the triggering force causing the actuation lever to apply the transverse force to the actuating rod 103.

In an implementation, the actuating rod 103 may be coupled to the membrane 106 by a hinge defining an axis of rotation of the actuating rod 103. The hinge may provide a more guided torquing action of the actuating rod 103 relative to one or more of the membrane 106, the cap 102, and the body 101. The axis of rotation may be substantially parallel to an exterior surface of the membrane 106.

In implementations, the pressure vessel 100A-100C is integral to and/or disposed within a pressure chamber of a beneficial agent dispensing or administration device (e.g., an autoinjector). In these implementations, the beneficial agent dispensing or administration device may include an internal actuator to apply the transverse force 108 to the actuating rod. In an implementation, the internal actuator can be activated by an element (e.g., a button or switch) located on the exterior of the beneficial agent dispensing or administration device. Examples of beneficial agent dispensing devices (e.g., auto-injectors) are described in U.S. Pat. No. 10,716,901, which is incorporated by reference herein.

In an implementation, the actuating rod 103 extends through the membrane 106 and further extends into the interior 111 of the pressure vessel 100A-100C. In an implementation, an interior portion of the actuating rod 103 extends from an interior surface 112 of the membrane 106. In an implementation, an exterior portion of the actuating rod 103 extends from an external surface 113 of the membrane 106. In an implementation, the portion of the actuating rod 103 that extends into the interior 111 of the pressure vessel 100A-100C includes a piercing member, as described herein. For example, a sharp portion of the piercing member is directed toward the membrane 106 in a direction in which the pressurized substance applies a pressurizing force to the membrane 106. In an implementation, a sharp portion of the piercing member is substantially concentrically arranged around the actuating rod. In an alternative implementation, the piercing member includes multiple sharp portions that may be radially symmetrically distributed about the actuating rod 103. In an implementation, the piercing member extends laterally from the actuating rod 103. In this implementation, the piercing member may pierce a portion of the membrane 106 located laterally relative to the coupling between the membrane 106 and the actuating rod 103.

In implementations, the actuating rod 103 is a solid body without hollow portions. In an implementation, the coupling between the actuating rod 103 and the membrane 106 is continuous such that the membrane 106 does not interface with any hollow portions (if there are any) of the actuating rod 103. This continuous connection may reduce the force at any particular portion of the coupling between the membrane 106 and the actuating rod 103 necessary to rupture the membrane 106.

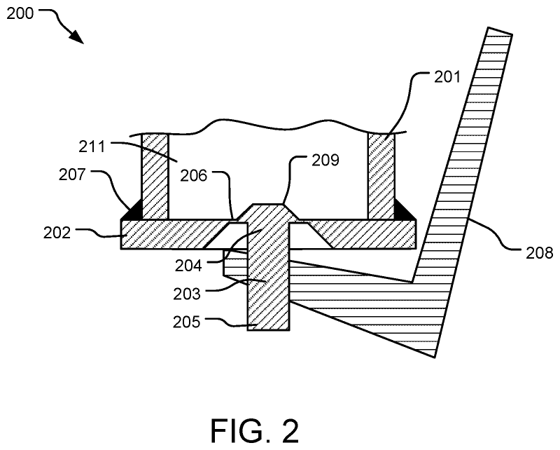

FIG. 2 illustrates a detailed section view of an example pressure vessel 200 with an activation lever 208. The pressure vessel 200 includes a body 201 and a cap 202 joined in a fluid-tight fashion via a weld (e.g., a circumferential weld). The cap 202 comprises a membrane 206 at least partially circumscribing an actuating rod 203. In an implementation, the membrane 206 may be rupturable or may be decouplable from one or more of the body 201 and the cap 202. The membrane 206 is illustrated as a thin, weakened portion of the cap 202 relative to other, more rigid portions of the cap 202. The actuating rod 203 comprises a proximal end 204 surrounded by the membrane 206 and extends axially to the distal end 205. By pushing the distal end of the actuating rod 203 in a radial or transverse direction, a torque is applied to the actuating rod 203, which in turn applies an amplified force to the membrane 206 proportional to the length of the actuating rod 203 divided by the diameter of the weakened portion 207.

In the illustrated implementation, an activation lever 208 is disposed over the distal end 205. The activation lever 208 is actuable to apply the transverse force to the actuating rod 203 and cause the actuating rod 203 to rupture the membrane 206. The activation lever 208 is an example of an actuator that provides an additional force advantage for rupturing the membrane 206. Other implementations of actuators are contemplated. For example, in implementations in which the pressure vessel 200 is integral to a beneficial agent dispensing or administration device (e.g., an autoinjector), a different actuator with a portion internally integrated into the beneficial agent administration device can be used. Examples of this include button-activated actuators that may include levers or may apply a direct transverse force to the actuating rod 203.

In some embodiments, the actuating rod 203 may comprise a protrusion 209 extending radially beyond the perimeter of the actuating rod 203 profile or beyond the radius for embodiments where the actuating rod 203 has a circular profile. As illustrated, the protrusion 209 is positioned in the interior 211 of the pressure vessel 200. In an implementation, the protrusion 209 reduces the surface area of the membrane 206 to a minimal gap between the rigid area of the cap 202 and the protrusion 209, thereby increasing the shear force vs. tension force in response to the torque being applied by the actuating rod 203, which translates to less energy being required for rupturing the membrane 206. In this regard, the force used to rupture the membrane 206 may be a shear force resulting from the application of the transverse force to the actuating rod 203. The manner in which the actuating rod 203 ruptures the membrane 206 may be affected or controlled by the physical geometry of the actuating rod 203 and/or the membrane 206, such as by a frangible indentation, slit, notch, or series of notches in the surface of the membrane 206 and/or in the actuating rod 203. In one embodiment, the cap 202 comprises the membrane 206 and the actuating rod 203, and these elements are manufactured as a single component by one or a combination of processes known in the art, such as machining, molding, metal injection molding, sintering, casting, stamping, and drawing. The cap 202 and the body 201 can be made from a variety of materials known in the art, including one or more of steel, stainless steel, aluminum, other metals, alloys, plastic, ceramics, frangible ceramic materials, or various composites.

In an implementation, the pressure vessel 200 may include a body 201, and a cap 202 joined to the body 201 in a fluid-tight fashion, a membrane 206, and an actuating rod 203. The actuating rod 203 comprises a proximal end 204 (e.g., a proximal end portion) joined to the pressure vessel 200 and a distal end 205 (e.g., a distal end portion) extending away from the pressure vessel 200. The arrangement is such that when the distal end 205 is moved in a direction generally perpendicular to a virtual line between the distal end 205 and the proximal end 204 (e.g., in response to a transverse force applied to the actuating rod 203), the proximal end 204 manipulates the membrane 206 to rupture. In one implementation, one or more of the cap 202, the membrane 206, and the actuating rod 203 are manufactured as a single component by one process or a combination of processes known in the art, such as machining, molding, metal injection molding, sintering, casting, stamping, and drawing. In some embodiments, the pressure vessel 200 may be manufactured without a cap 202, and the membrane 206 may be joined to the body 201 in a fluid-tight fashion as formed. In such embodiments, the membrane 206 and the actuating rod 203 may be manufactured as a single component by one or a combination of processes known in the art, such as machining, molding, metal injection molding, sintering, casting, stamping, and drawing.

The actuating rod 203 may include a piercing member having a geometry that follows the geometry of the membrane 206 and/or force concentration features in a confronting position to the membrane 206 to facilitate rupturing thereof. In an implementation, the piercing member or the force concentration feature extends laterally from the actuating rod 203. In this implementation, the piercing member or the force concentration feature may pierce or apply a concentrated force to a portion of the membrane 206 located laterally relative to the coupling between the membrane 206 and the actuating rod 203. In an implementation, following the geometry of the membrane means that the membrane and/or the weakened portion is substantially the same size and/or shape as the surface area of elements of the actuating rod that interface with or contact the membrane and/or the weakened portion. In an implementation, following the geometry means that a projection of the actuation rod 203 elements such as a piercing member or force concentration feature onto the membrane 206 at least partially defines the weakened portion of the membrane. For example, in an implementation, the weakened portion is broadly the same shape as the footprint of the force concentration on the membrane 206. For example, if the force concentration feature is radially symmetric, the weakened portion would be radially symmetric; if the force concentration feature is an ax-head shape, the weakened portion is similarly oblong.

The manner in which the actuating rod 203 is configured to rupture, fracture, or otherwise decouple the membrane 206 may be controlled by the physical geometry of the actuating rod 203 or membrane 206. For example, the geometry could include a frangible indentation, slit, notch, or series of notches in either or both of the actuating rod 203 and/or the membrane 206 of the pressure vessel 200. The pressure vessel 200 may be manufactured without a cap 202, such that the membrane 206 itself is joined to the body 201 in a fluid-tight fashion.

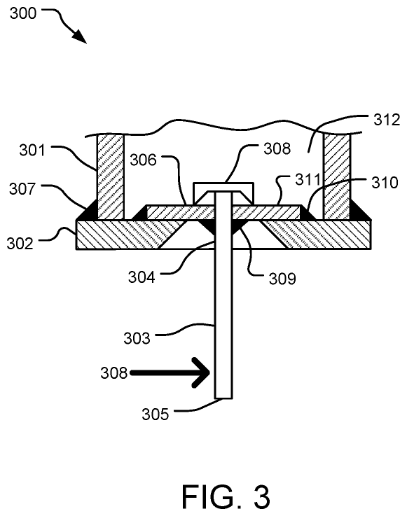

FIG. 3 illustrates a detailed section view of an example pressure vessel 300 with an interior piercing member. The pressure vessel 300 includes a body 301, a cap 302 joined in a fluid-tight fashion via a weld 307, and a membrane 311. The cap 302 comprises a central opening to which the membrane 311 is joined in a fluid-tight fashion via a weld 310. The unsupported portion of the membrane 311 covering the opening in the cap 302 forms a weakened portion 306 of the membrane. An actuating rod 303 comprises a distal portion 305 (e.g., a distal end) extending away from the body 301 and a proximal portion 304 (e.g., a proximal end) that extends through an opening in the membrane 311 to an interior 312 of the pressure vessel 300 adapted to hold pressurized contents. The actuating rod 303 is joined to the membrane 311 in a fluid-tight fashion via a weld 309. A rod head 308 extends radially from the proximal portion 304 of the actuating rod 303. The rod head 308 comprises force concentration features in a confronting position to the weakened portion 306 of the membrane 311. A force concentration feature is a rigid portion that has a smaller surface area exposure to the membrane than other portions of the actuating rod 303. This smaller surface area receives the force applied by the actuating rod 303 to apply concentrated pressure on a particular portion of the membrane 311. In the illustrated implementation, the rod head 308 has a cross-section shaped like an ax head. For example, the rod head 308 may be shaped like an ax head or the cross-section may be representative of a radially symmetrical shape with a continuous distal circumference (e.g., the rod head is annular and/or concentric about an elongate portion of the actuating rod 303.

When a transverse force is applied to the distal portion 305 of the actuating rod 303, it introduces a torque to the actuating rod 203 that translates into a force applied by the force concentration feature of the rod head 308 to the weakened portion 306 of the membrane 311, thereby facilitating the rupture of the weakened portion 306 of the membrane 311. The membrane can be made from a film, foil, sheet metal, or other frangible section, and the thickness, geometry, and fracture characteristics may be precisely controlled during manufacturing. One or more of the welds 307, 309, and 310 may be circumferential welds about one or more of the elements welded. Depending on the materials and manufacturing processes, the welds 307, 309, and 310 could be substituted by equivalent joining methods, including but not limited to soldering, gluing, ultrasonic welding, spin welding, laser welding, and solvent bonding.

In an implementation, a portion of the actuating rod 303 that extends into the interior of the pressure vessel 300 includes a piercing member, as described herein. For example, a sharp portion of the piercing member is directed toward the membrane 311 and/or the weakened portion 306 in a direction in which the pressurized substance applies a pressurizing force to the membrane 311. In an implementation, a sharp portion of the piercing member is substantially concentrically arranged around the actuating rod 303. In an alternative implementation, the piercing member includes multiple sharp portions that may be radially symmetrically arranged about the actuating rod 303. In an implementation, the piercing member extends laterally from the actuating rod 303. In this implementation, the piercing member may pierce a portion of the membrane 311 and/or the weakened portion 306 located laterally relative to the coupling between the membrane 311 and the actuating rod 303.

In an implementation, the pressure vessel 300 includes a body 301, a cap 302 joined to the body 301 in a fluid-tight fashion, a membrane 311, and an actuating rod 303. The actuating rod 303 comprises a proximal portion 304 joined to the pressure vessel 300, and a distal portion 305, extending away from the pressure vessel 300. The arrangement is such that when the distal portion 305 is actuated in a direction generally perpendicular to the virtual line between the distal portion 305 and the proximal portion 304, the proximal portion 304 manipulates the weakened portion 306 to rupture. The membrane 311 may be joined to the cap 302 in a fluid-tight fashion. The actuating rod 303 may be joined to the membrane 311 in a fluid-tight fashion.

The manner in which the actuating rod 303 is configured to rupture, fracture, or decouple the membrane 311 may be controlled by the physical geometry of the actuating rod 303 or membrane 311. For example, the geometry could include a frangible indentation, slit, notch, or series of notches in either or both of the actuating rod 303 and/or the membrane 311 of the pressure vessel 300.

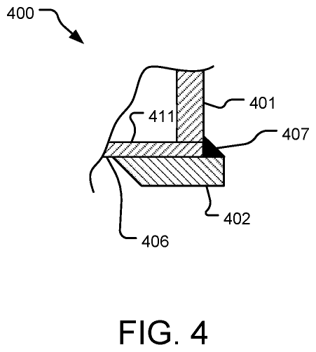

FIG. 4 illustrates a detailed section view of an example of a side of a pressure vessel 400. The pressure vessel 400 includes a body 401 and a cap 402. The cap 402 comprises an opening covered by a membrane 411. An unsupported region (e.g., unsupported by rigid elements of one or more of the body 401 and/or the cap 402) of the membrane 411 defines a weakened portion 406 (e.g., a rupturable region). In the illustrated implementation, the membrane 411 extends to the outer perimeter of the body 401, in-between the body 401 and the cap 402. The cap 402 and the membrane 411 are joined in a fluid-tight fashion via a weld 407. Depending on the materials of construction and manufacturing processes and the desired characteristics of the final product, the weld 407 could be substituted by equivalent joining methods, including soldering, gluing, ultrasonic welding, spin welding, laser welding, solvent bonding, etc.

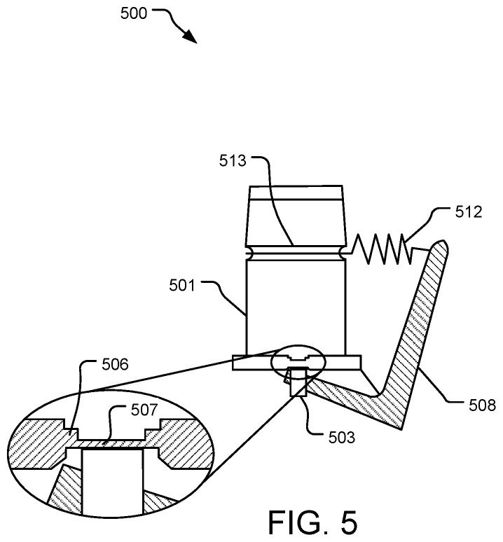

FIG. 5 illustrates an example of a pressure vessel 500 with a biasing element 512 and an actuator 508. FIG. 5 also illustrates an interior cross-sectional view of a portion of the pressure vessel 500. The pressure vessel 500 includes a body 501, an actuating rod 503, and the actuator 508 (e.g., an actuating lever). In an implementation, the pressure vessel 500 is similar in form and function to the implementation of the pressure vessel 200 illustrated in FIG. 2. A biasing element 512 (e.g., a spring, an elastic band, or a pneumatic/pressurized element) biases the actuator 508 toward a counterclockwise rotation, thereby introducing a torque to the actuating rod 503, which in turn applies a force on a weakened portion 507 (e.g., a rupturable region) of a membrane 506. The force applied by the biasing element 512 may be adjusted such that the spring alone may cause the weakened portion 507 to rupture when the actuator 508 is released to move. Alternatively, the force applied by the biasing element 512 may be adjusted such that the spring alone cannot cause the weakened portion 507 to rupture but merely assist this action when another force is applied to the actuator 508. The body 501 may comprise a groove 513 into which an arm of the biasing element 512 is disposed. The groove 513 can be replaced with an ear, a hook, or a flange to serve the same function. The manner in which the actuating rod 503 is configured to rupture, fracture, or decouple the membrane 506 may be controlled by the physical geometry of the actuating rod 503 or membrane 506. For example, the geometry could include a frangible indentation, slit, notch, or series of notches in either or both of the actuating rod 503 and/or the membrane 506 of the pressure vessel 500.

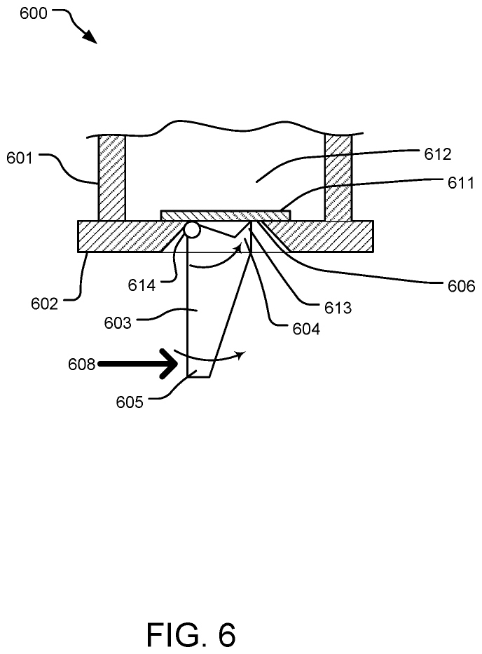

FIG. 6 illustrates a detailed section view of an example of a pressure vessel 600, including an actuating rod 603 with a sharp portion 613. The pressure vessel 600 includes a body 601 and a cap 602. A central opening in the cap 602 is overlayed with membrane 611 to form a fluid-tight or hermetic seal to seal pressurized contents in an interior 612 of the pressure vessel 600. The unsupported section of the membrane 611 defines a weakened portion 606 (e.g., a rupturable region). An actuating rod 603 comprises a hinge 614 nested in or otherwise coupled to one or more of the cap 602 and the membrane 611. The actuating rod may further include a proximal portion 604 (e.g., a proximal end) in a confronting position (e.g., adjacent to or directly engaged to) to the weakened portion 606 and a distal portion 605 (e.g., a distal end). The proximal portion 604 is configured to rupture the weakened portion 606. In the illustrated implementation, the proximal portion includes the sharp portion 613 or a force concentration feature to rupture the weakened portion 606. When the distal portion 605 of the actuating rod 603 is moved to rotate the actuating rod 603 (e.g., in the directions of the rotational arrows in FIG. 6), the proximal portion 604 of the actuating rod 603 ruptures the weakened portion 606. The force advantage includes a decreased transverse force 608 to be applied to the distal portion 605 of the actuating rod 603 for the proximal portion 604 to rupture the weakened portion 606 relative to a direct force applied to the actuating rod 603 in the direction of the rupture. The transverse force 608 applied to the distal portion 605 to rupture the membrane 611 may be substantially proportional to the distance from the hinge axis of the hinge 614 to the distal portion 605 divided by the distance between the hinge axis of the hinge 614 and the proximal portion 604.

The manner in which the actuating rod 603 is configured to rupture, fracture, or decouple the membrane 611 may be controlled by the physical geometry of the actuating rod 603 or the membrane 611. For example, the geometry may include a frangible indentation, slit, notch, or series of notches in either or both of the actuating rod 603 and/or the membrane 611 of the pressure vessel 600.

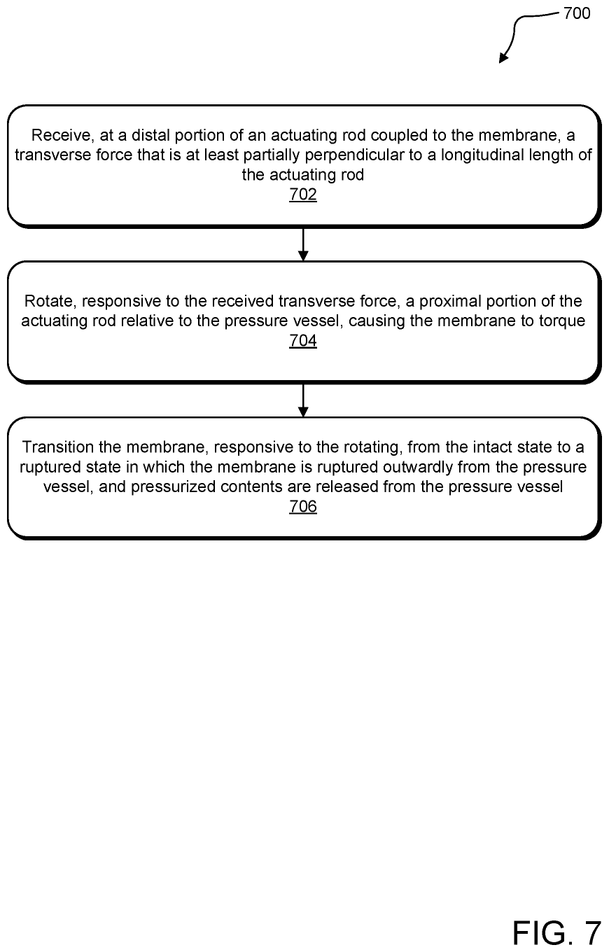

FIG. 7 illustrates example operations 700 of rupturing a membrane that hermetically seals a pressure vessel in an intact state. A receiving operation 702 receives, at a distal portion of an actuating rod coupled to the membrane, a transverse force that is at least partially perpendicular to a longitudinal length of the actuating rod.

For example, a pressure vessel includes a membrane in an intact state. In the intact state, the membrane maintains a hermetic seal between the membrane and an interior of the pressure vessel. The pressure vessel includes a body and a cap. In an implementation, the membrane may be rupturable or may be decouplable from one or more of the body and the cap. The body may be composed of metals or alloys such as steel, stainless steel, or aluminum. The cap may be coupled to the body in a fluid-tight fashion to hermetically seal pressurized content within the body. In an implementation, the cap is sealed between rigid portions or otherwise coupled to a rigid portion of the body. The pressurized contents may include a pressurized fluid that is compressed and/or liquified. Examples of pressurized contents containable within the pressure vessel include carbon dioxide, oxygen, nitrogen, argon, helium, hydrocarbons, fluorocarbons, ethers, or a mixture of gasses or other pressurized fluids. Examples of common liquified gasses include fluorocarbons, ethers, and other hydrocarbons.

In an implementation, the cap includes a membrane. The cap and/or the membrane may be coupled to or integral with an actuating rod. The actuating rod includes a proximal portion (e.g., a proximal end) joined to the membrane and a distal portion (e.g., a distal end) extending distally away from the membrane. In the illustrated implementation, the actuating rod is illustrated as an elongate member. Implementations are contemplated in which the actuating rod is of a different shape, including one or more of a different three-dimensional polygon, a three-dimensional object with curvilinear sides, any combination thereof, and any other three-dimensional shape.

In an implementation, the actuating rod and the membrane are manufactured together as a singly formed component. In an implementation, the pressure vessel includes an actuation lever coupled to the actuating rod and a body of the pressure vessel. In this implementation, the actuating lever may be configured to selectively apply the transverse force to the actuating rod.

In an implementation, the actuating rod extends through the membrane and further extends into the interior of the pressure vessel. In an implementation, an interior portion of the actuating rod extends from an interior surface of the membrane. In an implementation, an exterior portion of the actuating rod extends from an external surface of the membrane. In an implementation, the portion of the actuating rod that extends into the interior of the pressure vessel includes a piercing member, as described herein. For example, a sharp portion of the piercing member is directed toward the membrane in a direction in which the pressurized substance applies a pressurizing force to the membrane. In an implementation, a sharp portion of the piercing member is substantially concentrically arranged around the actuating rod. In an alternative implementation, the piercing member includes multiple sharp portions that may be radially symmetrically distributed about the actuating rod. In an implementation, the piercing member extends laterally from the actuating rod. In this implementation, the piercing member may pierce a portion of the membrane located laterally relative to the coupling between the membrane and the actuating rod.

In an implementation, the received transverse force is an eccentric force that causes a rotation. In this implementation, the eccentric force transitions the membrane from the intact state to the ruptured state by rotating the actuating rod substantially around the coupling between the actuating rod and the membrane. In an implementation, two or more of the cap, actuating rod, and the membrane are manufactured together as a singly formed component.

In an implementation, the received (or actuated) transverse force is a force that has a component that is substantially perpendicular to a central longitudinal axis along a longitudinal length of the actuating rod. In an implementation, the component of the transverse force that is substantially perpendicular to the central longitudinal axis along the longitudinal length of the actuating rod is greater than a component of the force that is parallel to the central longitudinal axis. In implementations in which the actuating rod is differently shaped, the central longitudinal axis that represents a reference for the transverse force may be virtually represented as a line substantially normal to the membrane at a point (e.g., a central point) of the coupling between the membrane and the actuating rod.

In an implementation, the received (or actuated) transverse force is a force that has a component that is substantially perpendicular to a central longitudinal axis along a longitudinal length of the actuating rod. In an implementation, the component of the transverse force that is substantially perpendicular to the central longitudinal axis along the longitudinal length of the actuating rod is greater than a component of the force that is parallel to the central longitudinal axis. In implementations in which the actuating rod is differently shaped, the central longitudinal axis that represents a reference for the transverse force may be virtually represented as a line substantially normal to the membrane at a point (e.g., a central point) of the coupling between the membrane and the actuating rod.

In implementations, the actuating rod may be further coupled at the distal portion to an actuator (e.g., a lever) that applies the transverse force to the actuating rod. In an implementation, the actuator is coupled to the body by a biasing element (e.g., a spring, elastic band, or a pneumatic/pressurized element) coupled to the pressure vessel. For example, the biasing element may be adapted to apply a triggering force to the actuation lever responsive to a release of the biasing element, the triggering force causing the actuation lever to apply the transverse force to the actuating rod.

In implementations, the pressure vessel is integral to and/or disposed within a pressure chamber of a beneficial agent dispensing or administration device (e.g., an autoinjector). In these implementations, the beneficial agent dispensing or administration device may include an internal actuator to apply the transverse force to the actuating rod. In an implementation, the internal actuator can be activated by an element (e.g., a button or switch) located on the exterior of the beneficial agent dispensing or administration device. Examples of beneficial agent dispensing devices (e.g., auto-injectors) are described in U.S. Pat. No. 10,716,901, which is incorporated by reference herein.

In implementations, the actuating rod is a solid body without hollow portions. In an implementation, the coupling between the actuating rod and the membrane is continuous such that the membrane does not interface with any hollow portions (if there are any) of the actuating rod. This continuous connection may reduce the force at any particular portion of the coupling between the and the actuating rod necessary to rupture the membrane.

A rotating operation 704 rotates, responsive to the received transverse force, a proximal portion of the actuating rod relative to the pressure vessel, causing the membrane to torque. In an implementation, the rotating operation 704 includes rotating the actuating rod substantially around the coupling between the actuating rod and the membrane. In an implementation, when a transverse force is applied to the distal portion, the proximal portion torques against a coupled portion of the membrane, causing the actuating rod to rupture the membrane (e.g., pierce the membrane or decouple the membrane from one or more of the cap and the body). The arrangement is such that when the distal portion is moved in a direction generally perpendicular to a virtual line or central longitudinal axis between the distal portion and the proximal portion, the proximal portion manipulates the membrane to rupture. In an implementation, the received (or actuated) transverse force is an eccentric force that transitions the membrane from the intact state to the ruptured state by rotating the actuating rod substantially around the coupling between the actuating rod and the membrane.

In an implementation, the pressure vessel includes a hinge that couples the actuating rod to the membrane, the hinge defining an axis of rotation of the actuating rod, the axis of rotation being substantially parallel to an exterior surface of the membrane. In this implementation, the rotating operation 704 further includes rotating the actuating rod about the axis of rotation. For example, the actuating rod may be coupled to the membrane by a hinge defining an axis of rotation of the actuating rod. The hinge may provide a more guided torquing action of the actuating rod relative to one or more of the membrane, the cap, and the body. The axis of rotation may be substantially parallel to an exterior surface of the membrane.

A transitioning operation 706 transitions the membrane, responsive to the rotating from the intact state in which the membrane hermetically seals the pressure vessel to a ruptured state in which the membrane is ruptured outwardly from the pressure vessel, and pressurized contents are released from the pressure vessel.

In an implementation, the membrane ruptures to transition from the intact state to the ruptured state responsively to the received transverse force satisfying a rupture condition. In an implementation, the rupture condition may be based on a predetermined force threshold based on one or more of a pressure applied by the pressurized substance to the membrane, a configuration (e.g., the composition or thickness) of the membrane (and/or the weakened portion), a configuration of the actuating rod relative to the membrane, a configuration of an actuator configured to apply the transverse force to the actuating rod, a biasing force (e.g., a spring force) that a biasing element (e.g., a spring, an elastic band, or a pneumatic element) is configured to selectively (e.g., responsive to a releasing action) apply to the actuator, and the like.

In an implementation, the actuating rod of the pressure vessel is configured to rupture the membrane inwardly into an interior of the pressure vessel. In an implementation, the proximal portion ruptures the membrane inwardly. In this implementation, the membrane may remain partially joined to the membrane on the side of the coupling between the membrane and the actuating rod from which an actuating force is applied to the distal portion of the actuating rod.

In an implementation, the transverse actuation of the actuating rod ruptures the membrane outwardly from the pressure vessel in substantially the same direction as a pressure force applied to the membrane by the pressurized contents. In an implementation, the transitioning operation 706 deforms, by the actuating rod, the membrane to increase a hermetically sealed volume contained by the membrane and the pressure vessel prior to rupturing the membrane.

In an implementation, the pressure vessel further includes a force concentration feature coupled to the actuating rod and the membrane. In this implementation, the transitioning operation 706 further includes applying a concentrated force by the force concentration feature to the membrane. In an implementation, the actuating rod includes a piercing member that engages the membrane in the intact state, and the transitioning operation 706 includes piercing by the piercing member, the membrane.

In an implementation, the membrane includes a weakened portion, and the transitioning operation 706 includes a rupturing operation that ruptures the membrane at the weakened portion. In an implementation, the weakened portion is weakened asymmetrically around the coupling between the actuating rod and the membrane. In implementations, the weakened portion in the cap may at least partially define the membrane. The weakened portion may be adapted to selectively rupture when sufficient force is applied. In an implementation, the weakened portion couples the membrane to the cap and/or the body. In another implementation, the weakened portion couples the cap to the body, with the cap serving as the membrane. The weakened portion may be a portion of the membrane and/or the cap that is thinned (or molded to have a thinner width through which to rupture than other portions of the membrane or the cap) or of a different composition than other, more rigid portions of the membrane and/or the cap. In an implementation, the weakened portion at least partially circumscribes the coupling between the actuating rod and the membrane. In an implementation, the weakened portion is weakened asymmetrically around the coupling between the actuating rod and the membrane.

In another implementation, the actuating rod is configured to rupture the membrane of the pressure vessel outwardly to extend distally from the pressure vessel (or distally from the location of the rupture). In an implementation, the transverse force causes a transverse actuation of the actuating rod that ruptures the membrane outwardly from the pressure vessel in substantially the same direction as a pressure force applied to the membrane by the contained pressurized substance. In an implementation in which an interior portion of the actuating rod is situated in the interior of the pressure vessel in the intact state, a greater portion of the actuating rod is in the interior of the pressure vessel in the intact state than in the pressure vessel in the ruptured state.

In an implementation in which the proximal portion ruptures the membrane outwardly, the ruptured portion of the membrane may remain partially joined to the rest of the membrane on the side opposite that from which an actuating force is applied to the distal portion of the actuating rod. The manner in which the actuating rod is configured to rupture, fracture, or decouple the membrane may be controlled by the physical geometry of the actuating rod or membrane. For example, the geometry could include a frangible indentation, slit, notch, or series of notches in either or both of the actuating rod and the membrane of the pressure vessel. The pressure vessel may be manufactured without a cap, wherein the membrane is joined to the body in a fluid-tight fashion. The actuating rod may comprise a piercing member having a geometry that follows the geometry of the membrane and/or force concentration features in a confronting position to the membrane to facilitate rupturing of the membrane. In this and other embodiments, the force concentration features and/or geometry that follow the geometry of the membrane or a weakened portion (e.g., a rupturable region) of the membrane can be incorporated directly into the actuating rod. In an implementation, following the geometry of the membrane means that the membrane and/or the weakened portion is substantially the same size and/or shape as the surface area of elements of the actuating rod that interface with or contact the membrane and/or the weakened portion. In an implementation, following the geometry means that a projection of the actuation rod elements such as a piercing element or force concentration feature onto the membrane at least partially defines the weakened portion of the membrane. For example, in an implementation, the weakened portion is broadly the same shape as the footprint of the force concentration feature on the membrane. If the force concentration feature is radially symmetric, the weakened portion would be radially symmetric; if the force concentration feature is an ax-head shape, the weakened portion is similarly oblong.

Applying the transverse force to the distal portion provides a mechanical force advantage compared with applying a direct force to the actuating rod in the direction of the membrane. The transverse force required to rupture the membrane may be less than the direct force in the direction of the membrane required to rupture the membrane. In an implementation, the actuating rod may have a triangular or another edged or sharp profile, which further decreases the actuating force required to rupture the membrane at a point of interaction of a vertex, edge, or corner of the edged or sharp profile and the membrane.

In an implementation, a section of the pressure vessel that includes the actuating rod and the membrane is disposed within a pressure chamber of a beneficial agent dispensing device, and the transitioning operation 706 further includes releasing the pressurized contents into the pressure chamber to pressurize the pressure chamber. Examples of beneficial agent dispensing devices (e.g., auto-injectors) are described in U.S. Pat. No. 10,716,901, which is incorporated by reference herein.

In an implementation, a greater portion of the actuating rod is in the pressure vessel in the intact state than in the ruptured state. For example, the actuating rod extends through the membrane and from an interior surface of the membrane into the pressure vessel. In an implementation, a portion of the actuating rod that extends from an exterior surface of the membrane is elongated, a portion of the actuating rod that extends from an interior surface of the membrane includes a piercing member, and the transitioning operation 706 further includes a piercing operation that pierces, by the piercing member, the membrane. In an implementation, a sharp portion of the piercing member is directed toward the membrane in a direction in which the pressurized contents apply a pressurizing force to the membrane, and the transitioning operation 706 further includes a piercing operation that pierces, by the sharp portion, the membrane. In an implementation, a sharp portion of the piercing member is substantially concentrically arranged around the actuating rod, and the transitioning operation 706 further includes a piercing operation that pierces, by the sharp portion, the membrane. In an implementation, the piercing member extends laterally from the actuating rod, and the transitioning operation 706 includes a piercing operation that pierces, by the piercing member, a lateral portion of the membrane relative to the coupling between the membrane and the actuating rod.

The logical operations making up implementations of the technology described herein may be referred to variously as operations, steps, objects, or modules. Furthermore, it should be understood that logical operations may be performed in any order, adding or omitting operations as desired, regardless of whether operations are labeled or identified as optional, unless explicitly claimed otherwise or a specific order is inherently necessitated by the claim language.

An example pressure vessel with an interior adapted to contain a pressurized substance is provided. The pressure vessel includes a membrane, including an interior surface exposed to the interior of the pressure vessel. The membrane is adapted to hermetically seal the pressure vessel in an intact state and to release the pressurized substance in a ruptured state. The pressure vessel further includes an actuating rod coupled to and extending from an exterior surface of the membrane on an opposite side of the membrane relative to the interior surface. The actuating rod is adapted to transition the membrane from the intact state to the ruptured state in response to receiving a transverse force.

Another example pressure vessel of any preceding vessel is provided, wherein the transverse force is an eccentric force that causes the transition by rotating the actuating rod substantially around the coupling between the actuating rod and the membrane.

Another example pressure vessel of any preceding vessel is provided, wherein the actuating rod extends from the membrane distally.

Another example pressure vessel of any preceding vessel is provided, wherein transverse actuation of the actuating rod ruptures the membrane outwardly from the pressure vessel in substantially a same direction as a pressure force applied to the membrane by the contained pressurized substance.

Another example pressure vessel of any preceding vessel is provided, wherein the actuating rod and the membrane are manufactured together as a singly formed component.

Another example pressure vessel of any preceding vessel is provided, the pressure vessel further including an actuation lever adapted to apply the transverse force to the actuating rod.

Another example pressure vessel of any preceding vessel is provided, the pressure vessel further including an actuation lever coupled to the actuating rod and a biasing element coupled to the pressure vessel, the biasing element adapted to apply a triggering force to the actuation lever responsive to a release of the biasing element, the triggering force causing the actuation lever to apply the transverse force to the actuating rod.

Another example pressure vessel of any preceding vessel is provided, the pressure vessel further including a force concentration feature coupled to the actuating rod and the membrane.

Another example pressure vessel of any preceding vessel is provided, wherein the actuating rod is coupled to the membrane by a hinge defining an axis of rotation of the actuating rod, the axis of rotation being substantially parallel to the exterior surface of the membrane.

Another example pressure vessel of any preceding vessel is provided, wherein the actuating rod includes a piercing member that engages the membrane in the intact state, the piercing member having a geometry that follows the geometry of the membrane.

Another example pressure vessel of any preceding vessel is provided, wherein a section of the pressure vessel including the actuating rod and the membrane is disposed within a pressure chamber of a beneficial agent dispensing device.

Another example pressure vessel of any preceding vessel is provided, wherein the transition is responsive to the received transverse force satisfying a rupture condition, the rupture condition based on a predetermined force threshold based on pressure applied by the pressurized substance to the membrane and based on a configuration of the membrane.

Another example pressure vessel of any preceding vessel is provided, wherein a greater portion of the actuating rod is in the pressure vessel in the intact state than in the ruptured state.

Another example pressure vessel of any preceding vessel is provided, wherein the actuating rod further extends through the membrane and from the interior surface into the pressure vessel.

Another example pressure vessel of any preceding vessel is provided, wherein a portion of the actuating rod that extends from the exterior surface is elongated and wherein a portion of the actuating rod that extends from the interior surface includes a piercing member.

Another example pressure vessel of any preceding vessel is provided, wherein a sharp portion of the piercing member is directed towards the membrane in a direction in which the pressurized substance applies a pressurizing force to the membrane.

Another example pressure vessel of any preceding vessel is provided, wherein a sharp portion of the piercing member is substantially concentrically arranged around the actuating rod.

Another example pressure vessel of any preceding vessel is provided, wherein the piercing member extends laterally from the actuating rod.

Another example pressure vessel of any preceding vessel is provided, the membrane further including a weakened portion configured to rupture responsive to the received transverse force.

Another example pressure vessel of any preceding vessel is provided, wherein the weakened portion is weakened asymmetrically around the coupling between the actuating rod and the membrane.

Another example pressure vessel of any preceding vessel is provided, wherein the actuating rod is not hollow.

Another example pressure vessel of any preceding vessel is provided, wherein in the transition the actuating rod deforms the membrane such that the volume of the pressurized substance is increased.

Another example pressure vessel of any preceding vessel is provided, wherein the actuating rod is adapted to deform the membrane during the transition to increase a hermetically sealed volume contained by the membrane and the pressure vessel prior to rupturing the membrane.

An example method of rupturing a membrane that hermetically seals a pressure vessel in an intact state is provided. The method includes receiving, at a distal portion of an actuating rod coupled to the membrane, a transverse force that is at least partially perpendicular to a longitudinal length of the actuating rod. The method further includes rotating, responsive to the received transverse force, a proximal portion of the actuating rod relative to the pressure vessel, causing the membrane to torque. The method further includes transitioning the membrane, responsive to the rotating, from the intact state to a ruptured state in which the membrane is ruptured outwardly from the pressure vessel, and pressurized contents are released from the pressure vessel.

Another example method of any preceding method is provided, wherein the transverse force is an eccentric force that causes the rotating, the rotating including rotating the actuating rod substantially around the coupling between the actuating rod and the membrane.

Another example method of any preceding method is provided, wherein transverse actuation of the actuating rod ruptures the membrane outwardly from the pressure vessel in substantially a same direction as a pressure force applied to the membrane by the pressurized contents.

Another example method of any preceding method is provided, wherein the actuating rod and the membrane are manufactured together as a singly formed component.

Another example method of any preceding method is provided, wherein the pressure vessel further includes an actuation lever coupled to the actuating rod. The method further includes applying the transverse force to the actuating rod.

Another example method of any preceding method is provided, wherein the pressure vessel further includes an actuation lever coupled to the actuating rod and a biasing element coupled to the pressure vessel and the actuation lever. The method further includes applying, by the biasing element, a triggering force to the actuation lever responsive to a release of the biasing element, the triggering force causing the actuation lever to apply the transverse force to the actuating rod.

Another example method of any preceding method is provided, wherein the pressure vessel further includes an actuation lever coupled to the actuating rod and a biasing element coupled to the pressure vessel and the actuation lever. The method further includes applying, by the biasing element, a force to the actuation lever causing the actuation lever to apply the transverse force to the actuating rod.

Another example method of any preceding method is provided, wherein the pressure vessel further includes a force concentration feature coupled to the actuating rod and the membrane. The transitioning further includes applying a concentrated force by the force concentration feature to the membrane.

Another example method of any preceding method is provided, wherein the pressure vessel further includes a hinge that couples the actuating rod to the membrane, the hinge defining an axis of rotation of the actuating rod, the axis of rotation being substantially parallel to an exterior surface of the membrane. The rotating further includes rotating the actuating rod about the axis of rotation.

Another example method of any preceding method is provided, wherein the actuating rod includes a piercing member that engages the membrane in the intact state. The transitioning includes piercing by the piercing member, the membrane.

Another example method of any preceding method is provided, wherein a section of the pressure vessel including the actuating rod and the membrane is disposed within a pressure chamber of a beneficial agent dispensing device. The transitioning further includes releasing the pressurized contents into the pressure chamber to pressurize the pressure chamber.

Another example method of any preceding method is provided, wherein the transitioning is responsive to the received transverse force satisfying a rupture condition, the rupture condition based on a predetermined force threshold based on pressure applied by the pressurized contents to the membrane and based on a configuration of the membrane.

Another example method of any preceding method is provided, wherein a greater portion of the actuating rod is in the pressure vessel in the intact state than in the ruptured state.

Another example method of any preceding method is provided, wherein the actuating rod extends through the membrane and from an interior surface of the membrane into the pressure vessel.

Another example method of any preceding method is provided, wherein a portion of the actuating rod that extends from an exterior surface of the membrane is elongated and wherein a portion of the actuating rod that extends from an interior surface of the membrane includes a piercing member. The transitioning further includes piercing, by the piercing member, the membrane.

Another example method of any preceding method is provided, wherein a sharp portion of the piercing member is directed towards the membrane in a direction in which the pressurized contents apply a pressurizing force to the membrane. The piercing further includes piercing, by the sharp portion, the membrane.

Another example method of any preceding method is provided, wherein a sharp portion of the piercing member is substantially concentrically arranged around the actuating rod. The piercing further includes piercing, by the sharp portion, the membrane.

Another example method of any preceding method is provided, wherein the piercing member extends laterally from the actuating rod. The piercing further includes piercing, by the piercing member, a lateral portion of the membrane relative to the coupling between the membrane and the actuating rod.

Another example method of any preceding method is provided, the membrane including a weakened portion. The transitioning further includes rupturing the membrane at the weakened portion.

Another example method of any preceding method is provided, wherein the weakened portion is weakened asymmetrically around the coupling between the actuating rod and the membrane.

Another example method of any preceding method is provided, wherein the transitioning further deforms the membrane such that the pressurized substance volume is increased.

Another example method of any preceding method is provided, wherein the transitioning further deforms the membrane to increase a hermetically sealed volume contained by the membrane and the pressure vessel prior to rupturing the membrane.

An example system of rupturing a membrane that hermetically seals a pressure vessel in an intact state is provided. The system includes means for receiving, at a distal portion of an actuating rod coupled to the membrane, a transverse force that is at least partially perpendicular to a longitudinal length of the actuating rod. The system further includes means for rotating, responsive to the received transverse force, a proximal portion of the actuating rod relative to the pressure vessel, causing the membrane to torque. The system further includes means for transitioning the membrane, responsive to the rotating, from the intact state to a ruptured state in which the membrane is ruptured outwardly from the pressure vessel, and pressurized contents are released from the pressure vessel.

Another example method of any preceding system is provided, wherein the transverse force is an eccentric force that causes the rotating, the means for rotating including means for rotating the actuating rod substantially around the coupling between the actuating rod and the membrane.

Another example method of any preceding system is provided, wherein transverse actuation of the actuating rod ruptures the membrane outwardly from the pressure vessel in substantially a same direction as a pressure force applied to the membrane by the pressurized contents.

Another example system of any preceding system is provided, wherein the actuating rod and the membrane are manufactured together as a singly formed component.

Another example system of any preceding system is provided, wherein the pressure vessel further includes an actuation lever coupled to the actuating rod. The system further includes means for applying the transverse force to the actuating rod.

Another example system of any preceding system is provided, wherein the pressure vessel further includes an actuation lever coupled to the actuating rod and a biasing element coupled to the pressure vessel and the actuation lever. The system further includes means for applying, by the biasing element, a triggering force to the actuation lever responsive to a release of the biasing element, the triggering force causing the actuation lever to apply the transverse force to the actuating rod.

Another example system of any preceding system is provided, wherein the pressure vessel further includes an actuation lever coupled to the actuating rod and a biasing element, the biasing element adapted to apply a force to the actuation lever causing the actuation lever to apply transverse force to the actuating rod.

Another example system of any preceding system is provided, wherein the pressure vessel further includes a force concentration feature coupled to the actuating rod and the membrane. The means for transitioning further include means for applying a concentrated force by the force concentration feature to the membrane.

Another example system of any preceding system is provided, wherein the pressure vessel further includes a hinge that couples the actuating rod to the membrane, the hinge defining an axis of rotation of the actuating rod, the axis of rotation being substantially parallel to an exterior surface of the membrane. The means for rotating further include means for rotating the actuating rod about the axis of rotation.

Another example system of any preceding system is provided, wherein the actuating rod includes a piercing member that engages the membrane in the intact state. The means for transitioning include means for piercing, by the piercing member, the membrane.

Another example system of any preceding system is provided, wherein a section of the pressure vessel, including the actuating rod and the membrane is disposed within a pressure chamber of a beneficial agent dispensing device. The means for transitioning further include means for releasing the pressurized contents into the pressure chamber to pressurize the pressure chamber.

Another example system of any preceding system is provided, wherein the transitioning is responsive to the received transverse force satisfying a rupture condition, the rupture condition based on a predetermined force threshold based on pressure applied by the pressurized contents to the membrane and based on a configuration of the membrane.

Another example system of any preceding system is provided, wherein a greater portion of the actuating rod is in the pressure vessel in the intact state than in the ruptured state.

Another example system of any preceding system is provided, wherein the actuating rod extends through the membrane and from an interior surface of the membrane into the pressure vessel.

Another example system of any preceding system is provided, wherein a portion of the actuating rod that extends from an exterior surface of the membrane is elongated and wherein a portion of the actuating rod that extends from an interior surface of the membrane includes a piercing member. The means for transitioning further include means for piercing, by the piercing member, the membrane.

Another example system of any preceding system is provided, wherein a sharp portion of the piercing member is directed towards the membrane in a direction in which the pressurized contents apply a pressurizing force to the membrane. The means for piercing further include means for piercing, by the sharp portion, the membrane.

Another example system of any preceding system is provided, wherein a sharp portion of the piercing member is substantially concentrically arranged around the actuating rod. The means for piercing further include means for piercing, by the sharp portion, the membrane.

Another example system of any preceding system is provided, wherein the piercing member extends laterally from the actuating rod. The means for piercing further include means for piercing, by the piercing member, a lateral portion of the membrane relative to the coupling between the membrane and the actuating rod.

Another example system of any preceding system is provided, the membrane including a weakened portion. The means for transitioning further include means for rupturing the membrane at the weakened portion.

Another example system of any preceding system is provided, wherein the weakened portion is weakened asymmetrically around the coupling between the actuating rod and the membrane.

An example pressure vessel is provided. The pressure vessel includes a body, a rupturable membrane joined to the body in a fluid-tight fashion, and a containment volume defined by the body and the rupturable membrane, wherein the one of a liquid or a solid is enclosed and sealed in the containment volume. The pressure vessel further includes an actuating rod. The actuating rod includes a proximal end joined to the vessel and a distal end extending away from the vessel. The arrangement is such that when the distal end is moved in a direction generally perpendicular to a virtual line between the distal end and the proximal end, the proximal end manipulates the rupturable membrane to rupture, exposing the liquid or the solid to the atmosphere, resulting in a chemical reaction producing a volume of gas at least twice the volume of the containment volume at atmospheric pressure.

An example pressure vessel is provided. The pressurized gas vessel includes a body, a rupturable membrane joined to the body in a fluid-tight fashion, and an actuating rod. The actuating rod includes a proximal end joined to the vessel and a distal end extending away from the vessel. The arrangement is such that when the distal end is moved in a direction generally perpendicular to a virtual line between the distal end and the proximal end, the proximal end manipulates the rupturable membrane to rupture.

An example pressure vessel is provided. The pressurized gas vessel includes a body, a cap joined to the body at one end in a fluid-tight fashion, a rupturable membrane, and an actuating rod. The actuating rod includes a proximal end joined to the vessel and a distal end extending away from the vessel. The arrangement is such that when the distal end is moved in a direction generally perpendicular to a virtual line between the distal end and the proximal end, the proximal end manipulates the rupturable membrane to rupture.

Another example pressure vessel of any preceding vessel is provided, further including at least one cap joined to the body in a fluid-tight fashion.

Another example pressure vessel of any preceding vessel is provided, wherein the rupturable membrane is integral to and continuous with the cap and wherein the rupturable membrane is the thinnest portion of the cap.

Another example pressure vessel of any preceding vessel is provided, wherein the rupturable membrane and the actuating rod are integral to and continuous with the cap, the actuating rod including a protrusion extending beyond the cap towards the interior of the vessel, the protrusion being substantially thicker than the rupturable membrane, and wherein the rupturable membrane is a narrow, closed band formed between the cap and the protrusion.

Another example pressure vessel of any preceding vessel is provided, further including a lever having a proximal end and a distal end, the proximal end confronting the actuating rod. The lever is configured to pivot and tilt the actuating rod such that the distal end of the level travels a further distance than the distal end of the actuating rod.

Another example pressure vessel of any preceding vessel is provided, wherein the cap includes a central opening and supports the rupturable membrane on the interior side of the pressurized gas vessel, the rupturable membrane joined to the cap in a fluid-tight fashion, its perimeter being greater than that of the central opening, the rupturable membrane covering the entirety of the central opening, the portion above the opening unsupported by the cap defining the rupturable region of the rupturable membrane.

Another example pressure vessel of any preceding vessel is provided, wherein the actuating rod extends through an opening in the rupturable membrane to the inner side of the pressurized gas vessel and further includes a rod head at the proximal end. The rod head extends radially from the proximal end of the actuating rod and includes force concentration features in a confronting position to the rupturable membrane. When torque is applied to the distal end of the actuating rod, the force concentration features of the rod head transfer the force to the rupturable membrane on the side of the rupturable membrane opposite to the central opening, manipulating the rupturable membrane to rupture.

Another example pressure vessel of any preceding vessel is provided, wherein the actuating rod is joined to the membrane in a fluid-tight fashion one or more of welding, soldering, gluing, ultrasonic welding, spin welding, laser welding, and solvent bonding.

Another example pressure vessel of any preceding vessel is provided, wherein the cap is joined to the body in a fluid-tight fashion by one or more of welding, soldering, gluing, ultrasonic welding, spin welding, laser welding, and solvent bonding.

Another example pressure vessel of any preceding vessel is provided, wherein the rupturable membrane is joined to the body in a fluid-tight fashion by one or more of welding, soldering, gluing, ultrasonic welding, spin welding, laser welding, and solvent bonding.

Another example pressure vessel of any preceding vessel is provided, wherein the rupturable membrane is joined to the cap in a fluid-tight fashion by one or more of welding, soldering, gluing, ultrasonic welding, spin welding, laser welding, and solvent bonding.

Another example pressure vessel of any preceding vessel is provided, wherein the rupturable membrane extends to the outer perimeter of the body, in-between the body and the cap.

Another example pressure vessel of any preceding vessel is provided, wherein the rupturable membrane and the cap are manufactured as a single component by one or more of machining, molding, metal injection molding, sintering, casting, stamping, and drawing.

Another example pressure vessel of any preceding vessel is provided, wherein the rupturable membrane, the cap, and the actuating rod are manufactured as a single component by one or more of machining, molding, metal injection molding, sintering, casting, stamping, and drawing.

Another example pressure vessel of any preceding vessel is provided, further including a lever including a proximal end and a distal end, the proximal end confronting the distal end of the actuating rod, such that tilting the lever tilts the actuating rod and the distal end of the lever travels a longer distance than the distal end of the actuating rod.

Another example pressure vessel of any preceding vessel is provided, wherein the proximal end of the actuating rod includes a piercing member confronting the rupturable membrane, having a geometry that follows the geometry of the rupturable membrane.

Another example pressure vessel of any preceding vessel is provided, wherein the actuating rod further includes a piercing member confronting the rupturable membrane, having a rigid edge whose geometry follows the geometry of the central opening, such that a shear force is applied to the rupturable membrane when torque is applied to the actuating rod.

Another example pressure vessel of any preceding vessel is provided, wherein the piercing member includes sharp points or ridges that facilitate rupturing of the rupturable membrane.

Another example pressure vessel of any preceding vessel is provided, wherein a portion of the actuating rod includes sharp points or ridges that facilitate rupturing of the rupturable membrane.

Another example pressure vessel of any preceding vessel is provided, further including a spring attached at one end to the body and at the second end to the distal end of the lever. The spring biases the rotation of the lever in the counterclockwise direction, and the lever applies torque to the actuating rod.

Another example pressure vessel of any preceding vessel is provided, wherein the spring force alone is sufficient to rupture the rupturable membrane when transferred through the lever to the actuating rod and applied to the rupturable membrane.

Another example pressure vessel of any preceding vessel is provided, wherein the spring force alone is not sufficient to rupture the rupturable membrane when transferred through the lever to the actuating rod and applied to the rupturable membrane.

Another example pressure vessel of any preceding vessel is provided, wherein the proximal end of the actuating rod, including a hinge defining an axis of rotation of the actuating rod, the axis of rotation being parallel to the rupturable membrane, such that when torque is applied to the distal end of the actuating rod, the proximal end of the actuating rod ruptures the rupturable membrane.

Another example pressure vessel of any preceding vessel is provided, further including a hinge, the actuating rod rotatably attached to the hinge, the axis of rotation of the hinge being parallel to the rupturable membrane, such that when torque is applied to the distal end of the actuating rod, the proximal end of the actuating rod ruptures the rupturable membrane.

Another example pressure vessel of any preceding vessel is provided, whereupon rupturing of the rupturable membrane, a portion thereof moves in the direction opposite of the pressurized gas vessel interior, such that the pressurized gas facilitates the rupturing.

Another example pressure vessel of any preceding vessel is provided, wherein the body is produced from a section of metal pipe capped at both ends.

Another example pressure vessel of any preceding vessel is provided, wherein the rupturable membrane is integral to and continuous with the body and wherein the rupturable membrane is the thinnest portion of the body.

Another example pressure vessel of any preceding vessel is provided, further including a lever having a proximal end and a distal end. The proximal end confronts the actuating rod. The lever is configured to pivot and tilt the actuating rod such that the distal end of the level travels a further distance than the distal end of the actuating rod.

Another example pressure vessel of any preceding vessel is provided, wherein the actuating rod extends through an opening in the rupturable membrane to the inner side of the pressurized gas vessel and further includes a rod head at the proximal end. The rod head extends radially from the proximal end of the actuating rod and includes force concentration features in a confronting position to the rupturable membrane. When torque is applied to the distal end of the actuating rod, the force concentration features of the rod head transfer the force to the rupturable membrane on the side of the rupturable membrane opposite to the central opening, manipulating the rupturable membrane to rupture.

Another example pressure vessel of any preceding vessel is provided, wherein the actuating rod is joined to the membrane in a fluid-tight fashion one or more of welding, soldering, gluing, ultrasonic welding, spin welding, laser welding, and solvent bonding.

Another example pressure vessel of any preceding vessel is provided, wherein the rupturable membrane is joined to the body in a fluid-tight fashion by one or more of welding, soldering, gluing, ultrasonic welding, spin welding, laser welding, and solvent bonding.

Another example pressure vessel of any preceding vessel is provided, wherein the rupturable membrane and the body are manufactured as a single component by one or more of machining, molding, metal injection molding, sintering, casting, stamping, and drawing.

Another example pressure vessel of any preceding vessel is provided, wherein the rupturable membrane and the actuating rod are manufactured as a single component by one or more of machining, molding, metal injection molding, sintering, casting, stamping, and drawing.

Another example pressure vessel of any preceding vessel is provided, further including a lever including a proximal end and a distal end, the proximal end confronting the distal end of the actuating rod, such that tilting the lever tilts the actuating rod and the distal end of the lever travels a longer distance than the distal end of the actuating rod.

Another example pressure vessel of any preceding vessel is provided, further including a spring attached at one end to the body and at the second end to the distal end of the lever, biasing rotation of the lever in the counterclockwise direction, and the lever applying torque to the actuating rod.

Another example pressure vessel of any preceding vessel is provided, wherein the spring force alone is sufficient to rupture the rupturable membrane when transferred through the lever to the actuating rod and applied to the rupturable membrane.

Another example pressure vessel of any preceding vessel is provided, wherein the spring force alone is not sufficient to rupture the rupturable membrane when transferred through the lever to the actuating rod and applied to the rupturable membrane.

Another example pressure vessel of any preceding vessel is provided, wherein the rupturable membrane is integral to and continuous with the body and wherein the rupturable membrane is the thinnest portion of the body.

Another example pressure vessel of any preceding vessel is provided, further including a lever having a proximal end and a distal end, the proximal end confronting the actuating rod. The lever is configured to pivot and tilt the actuating rod such that the distal end of the lever travels a further distance than the distal end of the actuating rod.

Another example pressure vessel of any preceding vessel is provided, wherein the actuating rod extends through an opening in the rupturable membrane to the inner side of the pressurized gas vessel and further includes a rod head at the proximal end. The rod head extends radially from the proximal end of the actuating rod and includes force concentration features in a confronting position to the rupturable membrane. When torque is applied to the distal end of the actuating rod, the force concentration features of the rod head transfer the force to the rupturable membrane on the side of the rupturable membrane opposite to the central opening, manipulating the rupturable membrane to rupture.

Another example pressure vessel of any preceding vessel is provided, wherein the actuating rod is joined to the membrane in a fluid-tight fashion one or more of welding, soldering, gluing, ultrasonic welding, spin welding, laser welding, and solvent bonding.

Another example pressure vessel of any preceding vessel is provided, wherein the rupturable membrane is joined to the body in a fluid-tight fashion by one or more of welding, soldering, gluing, ultrasonic welding, spin welding, laser welding, and solvent bonding.

Another example pressure vessel of any preceding vessel is provided, wherein the rupturable membrane and the body are manufactured as a single component by one or more of machining, molding, metal injection molding, sintering, casting, stamping, and drawing.

Another example pressure vessel of any preceding vessel is provided, wherein the rupturable membrane and the actuating rod are manufactured as a single component by one or more of machining, molding, metal injection molding, sintering, casting, stamping, and drawing.

Another example pressure vessel of any preceding vessel is provided, further including a lever including a proximal end and a distal end, the proximal end confronting the distal end of the actuating rod, such that tilting the lever tilts the actuating rod and the distal end of the lever travels a longer distance than the distal end of the actuating rod.

Another example pressure vessel of any preceding vessel is provided, further including a spring attached at one end to the body and ad the second end to the distal end of the lever, biasing rotation of the lever in the counterclockwise direction, and the lever applying torque to the actuating rod.

Another example pressure vessel of any preceding vessel is provided, wherein the spring force alone is sufficient to rupture the rupturable membrane when transferred through the lever to the actuating rod and applied to the rupturable membrane.

Another example pressure vessel of any preceding vessel is provided, wherein the spring force alone is not sufficient to rupture the rupturable membrane when transferred through the lever to the actuating rod and applied to the rupturable membrane.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order or that all illustrated operations be performed to achieve desirable results. In some cases, the actions recited in the claims can be performed in a different order and still achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Thus, particular implementations of the subject matter have been described. Other implementations are within the scope of the following claims. Nevertheless, it will be understood that various modifications can be made without departing from the spirit and scope of the recited claims.

As used herein, terms such as “substantially,” “about,” “approximately,” or other terms of relative degree are interpreted as a person skilled in the art would interpret the terms and/or amount to a magnitude of variability of one or more of 1%, 2%, 3%, 4%, 5%, 6%, 7%, 8%, 9%, 10%, 11%, 12%, 13%, 14%, or 15% of a metric relative to the quantitative or qualitative feature described. For example, a term of relative degree applied to orthogonality suggests an angle may have a magnitude of variability relative to a right angle. When values are presented herein for particular features and/or a magnitude of variability, ranges above, ranges below, and ranges between the values are contemplated.

1. A pressure vessel with an interior adapted to contain a pressurized substance, comprising:
a membrane including an interior surface exposed to the interior of the pressure vessel, the membrane adapted to hermetically seal the pressure vessel in an intact state and to release the pressurized substance in a ruptured state; and
an actuating rod coupled to and extending from an exterior surface of the membrane on an opposite side of the membrane relative to the interior surface, the actuating rod adapted to transition the membrane from the intact state to the ruptured state in response to receiving a transverse force.

2-5. (canceled)

6. The pressure vessel of claim 1, further comprising an actuation lever adapted to apply the transverse force to the actuating rod.

7. The pressure vessel of claim 1, further comprising:
an actuation lever coupled to the actuating rod; and
a biasing element, the biasing element adapted to apply a force to the actuation lever, causing the actuation lever to apply transverse force to the actuating rod.

8. The pressure vessel of claim 1, further comprising a force concentration feature coupled to the actuating rod and the membrane.

9. The pressure vessel of claim 1, wherein the actuating rod is coupled to the membrane by a hinge defining an axis of rotation of the actuating rod, the axis of rotation being substantially parallel to the exterior surface of the membrane.

10. The pressure vessel of claim 1, wherein the actuating rod comprises a piercing member that engages the membrane in the intact state, the piercing member having a geometry which follows the geometry of the membrane.

11. The pressure vessel of claim 1, wherein a section of the pressure vessel including the actuating rod and the membrane is disposed within a pressure chamber of a beneficial agent dispensing device.

12. The pressure vessel of claim 1, wherein the transition is responsive to the received transverse force satisfying a rupture condition, the rupture condition based on a predetermined force threshold based on pressure applied by the pressurized substance to the membrane and based on a configuration of the membrane.

13. (canceled)

14. The pressure vessel of claim 1, wherein the actuating rod further extends through the membrane and from the interior surface into the pressure vessel.

15. The pressure vessel of claim 1, wherein a portion of the actuating rod that extends from the exterior surface is elongated and wherein a portion of the actuating rod that extends from the interior surface includes comprises a piercing member.

16. (canceled)

17. The pressure vessel of claim 15, wherein a sharp portion of the piercing member is substantially concentrically arranged around the actuating rod.

18. The pressure vessel of claim 15, wherein the piercing member extends laterally from the actuating rod.

19. The pressure vessel of claim 1, the membrane further comprising:
a weakened portion configured to rupture responsive to the received transverse force.

20-22. (canceled)

23. A method of rupturing a membrane that hermetically seals a pressure vessel in an intact state, the method comprising:
receiving, at a distal portion of an actuating rod coupled to the membrane, a transverse force that is at least partially perpendicular to a longitudinal length of the actuating rod;
rotating, responsive to the received transverse force, a proximal portion of the actuating rod relative to the pressure vessel, causing the membrane to torque; and
transitioning the membrane, responsive to the rotating, from the intact state to a ruptured state in which the membrane is ruptured outwardly from the pressure vessel, and pressurized contents are released from the pressure vessel.

24. The method of claim 23, wherein the transverse force is an eccentric force that causes the rotating, the rotating including rotating the actuating rod substantially around the coupling between the actuating rod and the membrane.

25-26. (canceled)

27. The method of claim 23, wherein the pressure vessel further includes an actuation lever coupled to the actuating rod, the method further comprising:
applying the transverse force to the actuating rod.

28. The method of claim 23, wherein the pressure vessel further includes an actuation lever coupled to the actuating rod and a biasing element coupled to the pressure vessel and the actuation lever, the method further comprising:
applying, by the biasing element, a force to the actuation lever causing the actuation lever to apply the transverse force to the actuating rod.

29. (canceled)

30. The method of claim 23, wherein the pressure vessel further includes a hinge that couples the actuating rod to the membrane, the hinge defining an axis of rotation of the actuating rod, the axis of rotation being substantially parallel to an exterior surface of the membrane, the rotating further comprising:
rotating the actuating rod about the axis of rotation.

31. The method of claim 23, wherein the actuating rod includes a piercing member that engages the membrane in the intact state, the transitioning comprising:
piercing, by the piercing member, the membrane.

32. (canceled)

33. The method of claim 23, wherein the transitioning is responsive to the received transverse force satisfying a rupture condition, the rupture condition based on a predetermined force threshold based on pressure applied by the pressurized contents to the membrane and based on a configuration of the membrane.

34.-42. (canceled)
